(19) United States
(12) Patent Application Publication
(10) Pub. No.: US 2022/0108392 A1
(43) Pub. Date: Apr. 7, 2022

(54) Platform for accessible, crowdfunded property ownership

(71) Applicant: Jason Clar, Brewster, NY (US)

(72) Inventor: Jason Clar, Brewster, NY (US)

(21) Appl. No.: 17/062,506

(22) Filed: Oct. 2, 2020

(51) Int. Cl. G06Q 40/04; G06Q 30/06; G06Q 10/10; G06Q 50/16; G06Q 50/26; G06Q 50/00; G06Q 40/02; G06Q 30/02; H04L 12/58

(52) U.S. Cl. CPC G06Q 40/04; G06Q 30/0645; G06Q 10/1053; G06Q 50/163; H04L 51/32; G06Q 50/01; G06Q 40/02; G06Q 30/0278; G06Q 50/26

(57) ABSTRACT

Described in this patent application is an entity which assumes ownership of various properties on the real estate market and monetizes them through renting and other means. The entity then lists all of their properties on its platform (namely a mobile ‘app’) to allow for its userbase to contribute a fraction of the property's overall assigned monetary value in exchange for a regular return based on user investment amount and revenues gained during the latest payment period. The entity also provides a platform for tenants and other occupants of the properties to communicate with each other as well as the entity itself, who will assign representatives to many of the properties to perform landlord, security, and other misc. duties. The idea of this entire configuration is to pitch it as a simple way for someone to begin investing in real estate, and could potentially mean cheaper rent for occupants as well.

### FIELD

This application relates to mobile device software & applications. Specifically, it relates to mobile softwares (or “apps”) in the investing & financial industries.

### BACKGROUND

In recent years, platforms & mobile softwares such as Robinhood have forever changed the landscape of stock market investing with their simplification of what was once a daunting and seemingly inaccessible prospect to the average person. As the disparity between socioeconomic classes continues to grow, userbases for these such “apps” are only going to continue growing, as everyday people look to stocks and other assets as a means of investing whatever they can spare in hopes of one day living more comfortably. However, stocks in particular are almost akin to gambling, and some would argue are only growing in volatility. As a result, those who were once some of the biggest stakeholders on Wall Street have begun distancing themselves, opting for alternative assets and securities—namely property. The problem with this, though, is that the average person has no way to realistically compete in this sector of investing, due to a lack of capital, lawyers, real estate agents, etc.

### SUMMARY

The platform to which this patent application pertains is an answer to the issue of investor (in)accessibility to the property/housing market and a model for corporate ownership of such assets.

BRAND X (the hypothetical corporate entity behind the investment platform/‘app’) will purchase properties on the market in full and assume ownership. Once a property's purchase is complete, it will be listed on APP X (the hypothetical name of the platform/‘app’) with photos and details, similar to the information found in an MLS listing. The listing will also entail what is called a “total cost of full ownership” for the purposes of this patent application, which is the value (in monetary currency) needed to be met collectively by the userbase in order for them to collect the maximum possible revenue incurred from the property. The cost of full ownership will be relative to the market value, quality, and other statistical data of the property at the time of listing on APP X. Further, and the main selling point of the platform, is that users will be able to contribute only a fraction of the total cost of ownership and in turn receive a corresponding share of the property's revenue, which will start coming to users on a weekly, bi-weekly, or monthly basis following their investment. Users will be required to invest a minimum amount to prevent dilution of revenue shares amongst users. The minimum will be calculated on a number of details and will be displayed to the users. Users will have the option of withdrawing their invested funds and subsequent profits from APP X and into their bank accounts after waiting a period of time (to be determined later), in order to avoid a sudden collapse in the platform's funding.

Revenues gained from the properties will initially come directly to BRAND X in various forms, as there is an intent to offer different property types including commercial, residential, land, etc. Every property invested in will get the user a return which is based on their initial investment, and the breakdown of how that return is derived will be displayed to the user upfront for more informed investing. The returns will be composed of a predetermined “Base Return” (BR), and a “Tenant Return” (TR) which may fluctuate from one month to the next. Users will regularly receive a BR on all property investments, regardless of land use, vacancy status, etc., but receive a TR for the properties which incur a form of income during the user's latest pay period. For example, BRAND X may purchase an entire apartment building and list it on APP X for a total ownership cost of $500,000. BRAND X will begin collecting rent and miscellaneous fees from tenants before the full ownership cost has been crowdfunded on APP X. The users who do contribute towards the overall goal will begin receiving their share of returns from their investments as soon as the next pay period, and BRAND X will absorb the remaining shares of revenue not yet claimed by other users. If the building has 100 occupied apartments, investors will receive a TR for those 100 tenants according to how much revenue they each generate. If the building hosts another 50 vacant apartments, investors will not receive any TR for them until they're filled.

Beyond simplified investing, the platform looks to redefine how residential communities communicate with each other and their “landlords”. Certain properties under BRAND X's ownership will provide on-site staff to carry out landlord duties, provide security, etc. to the property occupants. BRAND X will offer a secondary mobile ‘app’ (named APP Y for the purposes of this patent application) to provide a “Community Bulletin”/discussion board for tenants & occupants of each property to discuss their community-related questions, concerns, etc., and for other tenants and BRAND X to see & respond to accordingly. These discussion boards will in many ways resemble traditional social media platforms, including profiles with personable customization options, a direct messaging system, and the ability for users to share text posts, photos, videos, and other mixed media with each other.

APP Y's purpose is to simplify & separate the experience for users who do not invest. However, users of APP X who ore invested in a particular property will also be given some degree of access to the discussion board for that community. This is to promote the appearance of accountability and transparency on behalf of BRAND X towards its investing users.

### BRIEF DESCRIPTION OF THE DRAWINGS

This patent application is accompanied by several sketches/mock-ups of the ideas in question. All labels, values, section layouts, visual designs, etc. are for conceptual purposes and are subject to change before public release. As is the case for earlier sections of this writeup, BRAND X will be used in these sketch descriptions to denote the ultimate name of the corporate entity behind the mobile ‘app’, and A

X will be used in these sketch descriptions to denote the ultimate name of the mobile ‘app’ itself.

The sketch's figures are described as follows:

FIG. 1 is a mock-up of APP X's “Dashboard”, which will be the first screen users see upon opening the ‘app’.

FIG. 2 is a continuation of the view from FIG. 1, accessible to the user by scrolling ‘down’ on their touchscreen.

FIG. 3 is a mock-up of APP X's “Community Bulletin” section.

FIG. 4 is a mock-up of APP X's custom profiles for tenants & other users who utilize the Community Bulletin or direct messaging system.

FIG. 5 is a mock-up of APP X's “Browse” sect on, where users will navigate in order to view property listings available for their investment.

FIG. 6 is a mock-up of APP X's “Settings” section, which is where users will customize their ‘in-app experience’ such as display & notification settings, as well as change account information including email address, password, profile photo, etc.

FIG. 7 is a layout mock-up for a given property listing on APP X which the user has not yet financially invested in. Users will usually come to this screen after pressing a search result from the Browse section, or after being linked/referred to a listing on the app from a friend.

FIG. 8 is a continuation of the view from FIG. 7, accessible to the user by scrolling ‘down’ on their touchscreen.

FIG. 9 is a mock-up of a property listing on APP X which the user is already financially invested in. Users will typically arrive at this listing layout when pressing a property listing already in their ‘portfolio’ or on their Dashboard, as opposed to FIG. 7 & FIG. 8.

FIG. 10 is a continuation of the view from FIG. 9, accessible to the user by scrolling ‘down’ on their touchscreen.

FIG. 11 is a mock-up of APP X's “Invest” screen, which displays when a user chooses to initiate an investment in a given property of their choosing.

### DETAILED DESCRIPTION

It should be noted that although the enclosed sketches are illustrated as being on a mobile touchscreen device, and therefore built using technologies for Android OS and/or iOS software development, it is possible that future iterations of this platform and concept could release for other devices, including Desktop.

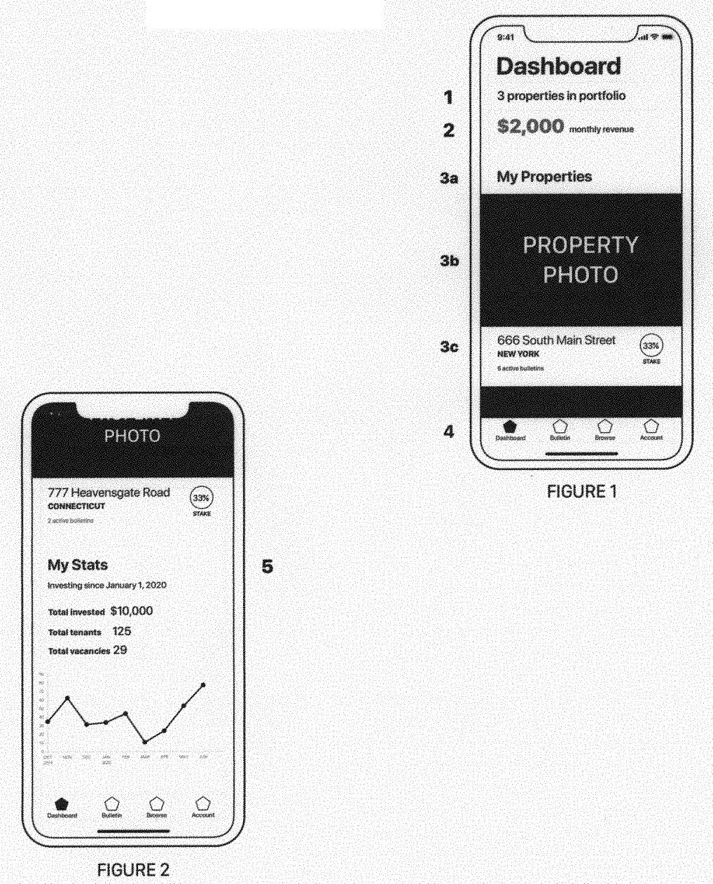

In FIG. 1, a ‘counter’ 1 displays to the user the number of properties of which they are currently invested in through our platform. In a similar vein, the user is shown the total calculated income they are earning 2, via our platform, as a result of their investments. Further, FIG. 1's “Dashboard” includes a list of the properties 3a which the user is currently invested in, with quick information and stats about the listings including photos of the property 3b, address, % share user has of the revenue, and Bulletin posts 3c. A bottom navigation menu 4 is illustrated in FIG. 1 as well as in every other FIG. of this patent application. It is constant throughout the entire user session on the ‘app’, only changing in its indication of which page the user is currently viewing.

In FIG. 2, the user is shown statistical data about their investment ‘portfolio’ 5, which will continue to change & update as time goes on and the user invests in more properties. Statistics may include total number of tenants under all of user's properties, total amount of money invested, date of user's first investment, etc. May also include automatically-generated visuals to depict user's portfolio growth/status, such as graphs or charts.

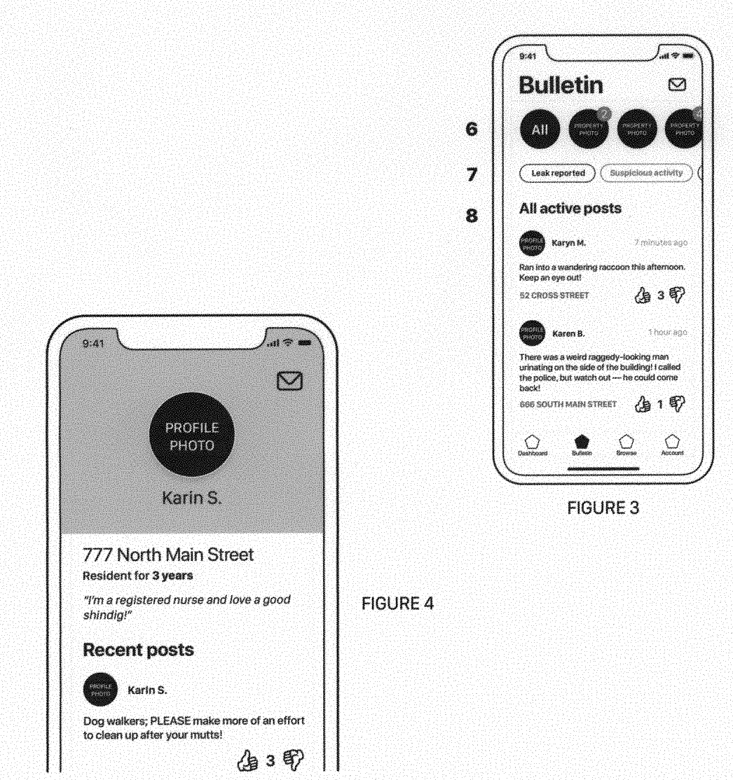

In FIG. 3, the “Bulletin” displays to the user a sliding list of their invested properties 6, allowing them to press one and view only the Bulletin posts for that property. The list also utilizes a visual indicator (in this case, badges) to signify important posts or alerts. Beyond this, FIG. 3 demonstrates another sliding set of buttons 7 which would be generated by AI algorithms, summarizing some of the most important sentiments expressed by tenants on their respective Bulletins. Finally, users will be shown a list of the Bulletin posts 8 which match their chosen filters (or lack thereof).

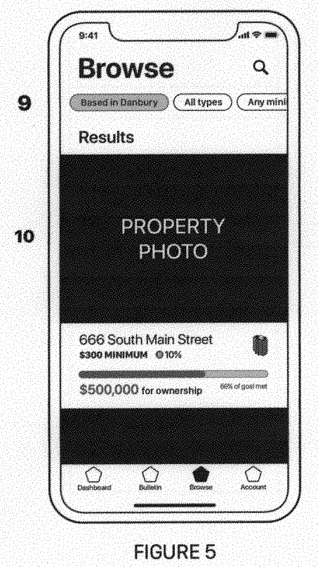

FIG. 5's “Browse” section utilizes another menu of filters 9 at the top of the section to allow users to narrow the types of properties displayed to them. Each property displayed will include stats & information such as photos, address, type of property, progress of crowdfunding, minimum investment required, etc. 10.

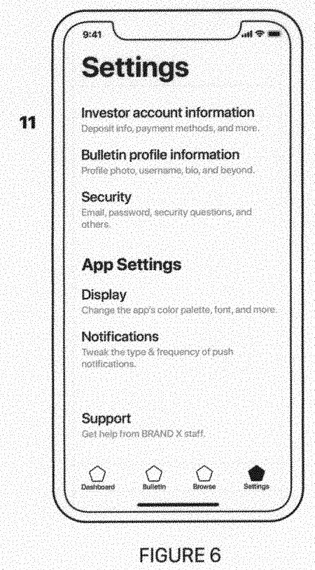

In FIG. 6, the “Settings” page includes a relatively standard set of options pertaining to the user's account & public profile, and the ‘app's’ user experience, such as display font settings, notifications, etc. 11.

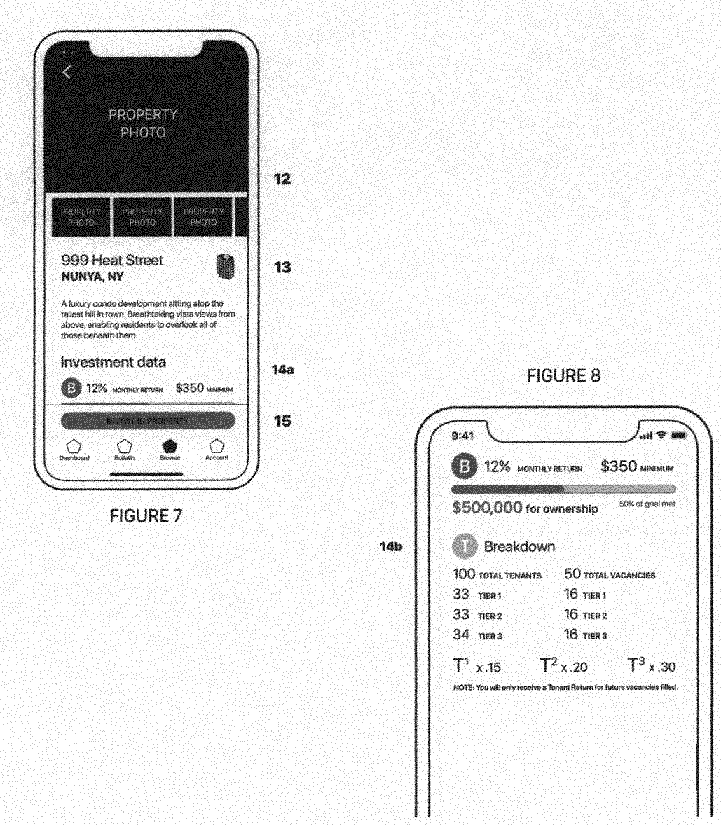

FIG. 7 demonstrates the section layout for a property listing of which the user is not yet invested, with detailed information including photo gallery 12 and address, type, etc. 13. Further, FIG. 7 & FIG. 8 detail the “Investment data” section which users will look to for more informed investing, including the listing's “Base Return” 14a as well as a breakdown of the property's “Tenant Return” rates 14b (the given configuration is for display purposes only). FIG 7 also shows the “Invest in Property” button 15, which users will press when they feel ready to initiate an investment in the given property.

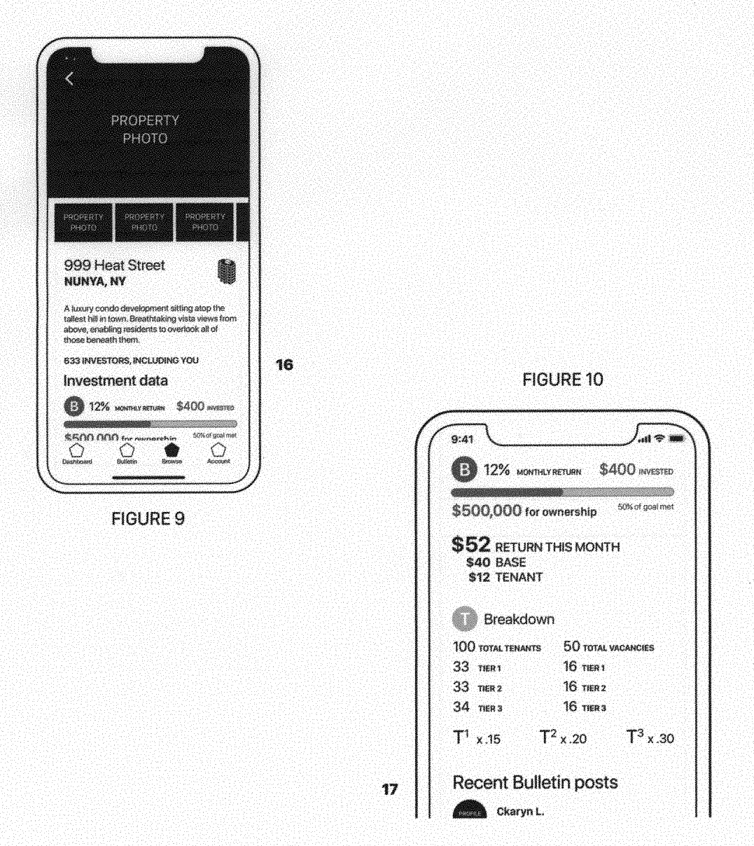

Alternatively, FIG. 9 shows the section layout for properties which the user is already invested in, with the main differences including a description of their investing position, a breakdown of their latest pay period earnings, and the total number of other investors 16. Further, FIG. 10 briefly shows how invested users will be given a higher degree of access to a given property's Bulletin 17 when compared to the restrictions placed on a user merely viewing the listing from afar.

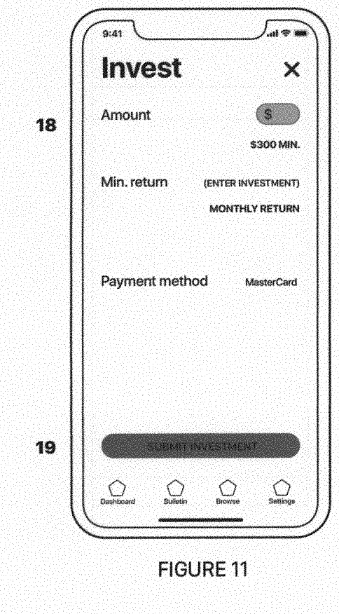

Finally, FIG. 11 illustrates the window which will display to the user when they press the aforementioned “Invest in Property” button. Users will enter the amount they wish to invest 18 (pursuant to the listing's minimum) and will be shown a breakdown of their minimum expected earnings according to the value they entered, followed by the option to choose payment/funding method. Finally, users will press the “SUBMIT INVESTMENT” button 19 to confirm their intent and initiate a transaction between APP X and the user's chosen funding method.

This patent application's concept offers a great opportunity to the average person with any degree of disposable income, including, but not limited to the ability for them to easily initiate their first investment in the real estate market, enabling them to take part in what will soon be massive activity in the sector. Further, it provides the chance for an entity such as BRAND X to own a multitude of assets on paper, while essentially getting covered for the costs by its users and sharing the profits with them in return.

The various aspects of what is described above can be used alone or in various combinations. Although the teaching of the present application has been described in detail for the purpose of illustration, it is understood that such detail is solely for that purpose, and variations can be made therein by those skilled in the art without departing from the scope of the teaching of this application. For example, the Tenant Return is currently determined by the actual revenue gained by the given occupant(s), but it is understood that the final iteration of the invention may determine the Tenant Return by other means. Further, the illustrations depict one visual style and format, but it is understood that these elements are subject to change and may be used in different combinations/layouts.

Whilst endeavoring in the foregoing specification to draw attention to those features of the invention believed to be of particular importance, it should be understood that protection is claimed in respect to any patentable feature or combination of features hereinbefore referred to and/or shown in the drawings, whether or net particular emphasis has been placed thereon.

1. An entity which acquires properties on the real estate market and assumes ownership.

2. An entity, according to claim 1, which rents and otherwise monetizes the owned properties.

3. An entity, according to claim 2, which provides employees or independent contractors to such properties to carry out landlord duties, act as security, etc.

4. A platform, accessible via web or software, which acts as an internet message board and allows occupants of the entity's properties (as described in claim 2) to communicate with each other as well as the entity itself.

5. A platform, accessible via web or software, which lists each property owned by the entity (as described in claim 1).

6. A platform, according to claim 5, which includes detailed information for each property listed, such as photo gallery, address, region, type of property (land, commercial, residential building, etc.).

7. A platform, according to claim 6, which associates a specific monetary value with each property listing, and which a user can contribute towards either fully or partially via payment by credit/debit card or bank transfer.

8. (canceled)

9. A platform, according to claim 7, which regularly pays the user a return based on their investment relative to other users' investments, property value, property revenue, etc.
